(19) United States
(12) Patent Application Publication
(10) Pub. No.: US 2026/0356004 A1
(43) Pub. Date: Nov. 12, 2026

(54) SYSTEM AND METHOD FOR MANUFACTURING ARCHITECTURAL CEMENTITOUS PRODUCTS

(71) Applicant: TUSCAN STONEWORX USA, LLC, Lindon, UT (US)

(72) Inventor: David L. NICOLSON, Lindon, UT (US)

(21) Appl. No.: 19/672,447

(22) Filed: May 8, 2026

Related U.S. Application Data
(60) Provisional application No. 63/977,803, filed on Feb. 6, 2026.
(60) Provisional application No. 63/802,917, filed on May 9, 2025.

(51) Int. Cl. B28B 3/20; C04B 28/04

(52) U.S. Cl. CPC B28B 3/20; C04B 28/04

(57) ABSTRACT

Disclosed are system configured to extrude cementitious compositions into desired shapes. The system may comprise an extrusion platform, an extruder head configured to deposit a cementitious composition onto a surface of the extrusion platform, and a conveyor system configured to adjust the relative position between the extruder head and the extrusion platform to continually extrude the cementitious composition along the length of the extrusion platform. The cementitious composition may be introduced into the interior of the extruder head through an inlet and then applied to the extrusion platform. As the extrusion platform moves and carries the cementitious composition relative to the extruder head, a mold apparatus forms the cementitious composition into a desired shape. In at least one embodiment, the lower surface of the mold may comprise dividers and side walls for forming the cementitious composition into continuous parallel strips of cementitious material.

### CROSS-REFERENCE TO RELATED APPLICATIONS

This Application claims the benefit of U.S. Provisional Application No. 63/977,803, filed Feb. 6, 2026, and U.S. Provisional Application No. 63/802,917, filed May. 9, 2025, which are incorporated by reference in their entirety.

### BACKGROUND

### Technical Field

This disclosure relates generally to systems and methods for manufacturing cementitious products, such as thin bricks and other architectural products.

### Related Technology

Building structures such as walls and fences are often built by organizing several individual masonry units into the structure. The masonry units may be pieces of cut stone, such as marble, granite, travertine, sandstone, or limestone. Frequently, masonry units are some form of brick. Bricks are typically laid together in an alternating pattern of offset courses and joined together using mortar. The relatively smaller bricks often seen in residential applications are typically made of clay combined with sand or other types of aggregate and are usually fired to provide suitable strength.

Thin bricks are relatively low cost and versatile for protecting the exteriors of a building and for use as an aesthetic covering, including interiors and/or exteriors of buildings. While many buildings may employ standard-sized bricks on building exteriors on the lower floors, such bricks may not be supported as the height of the building increases. This is due to the bricks on upper floors creating excessive loads on bricks underneath them at the lower levels of the building. Rather, thin brick having a relatively smaller thickness and weight may be used on the exteriors of the upper floors to maintain the structural stability of the brick at the lower floors and to provide a uniform appearance at the exterior of the building.

While standard-sized brick is now formed from industrial mechanized processes, many processes for manufacturing thin brick continue to rely on manual labor. This may lead to supply limitations and increased costs for finished thin brick.

Architectural products made from or that include curable cementitious compositions can be used to make other decorative features for buildings. These include cast stone products made using disposable molds, such as polystyrene molds. In some cases, a cementitious shell is formed over a polystyrene core within a larger polystyrene mold. While architectural products made in this fashion can have the realistic look of real cut stone, the molding process can be time and labor intensive.

Accordingly, there is a need for improved and efficient system and methods for manufacturing thin brick or other desired architectural products.

### SUMMARY

Disclosed are embodiments of conveyor and extrusion systems for manufacturing architectural products, such as thin bricks or lightweight extruded products, from a cementitious composition. The conveyor and extrusion system includes an extrusion platform and optional substrate configured to receive a cementitious composition, an extrusion system or subsystem configured to receive and extrude the cementitious composition onto the extrusion platform and optional substrate, and a conveyance system or subsystem configured to reliably support, carry, and maintain the extrusion platform in a desired position and movement relative to the extrusion system. In some embodiments, conveyor and extrusion systems can include a cutting and/or drying system or subsystem downstream from the extrusion system.

The extrusion system or subsystem for extruding the cementitious composition onto the extrusion platform and optional extrusion substrate comprises one or more extruder heads, each including a manifold, an inlet extending from the manifold that provides means for receiving an extrudable cementitious composition, and a mold apparatus configured to shape the extruded cementitious composition into a desired shape. An optional outlet may extend from the manifold to enable air trapped within the extruder head to escape.

The conveyance system comprises one or more pinions, gears, chains, or other drive means configured to engage corresponding recesses and/or teeth on or associated with one or more extrusion platforms in order to move each extrusion platform in a desired position and speed along the conveyor relative to the one or more extruder heads. In some embodiments, the one or more extrusion platforms have a length and a width, wherein a linear rack is disposed or formed along each of opposing first and second edges that define the length and configured to engage the one or more pinions, gears, chains, or other drive means. In another embodiment, the extrusion platform includes recesses near the first and second edges configured to engage with one or more pinions, gears, or other drive means. In another embodiment, the extrusion platform includes a linear rack disposed on a lower side of the extrusion platform configured to engage one or more appropriately positioned pinions, gears, or other drive means.

The mold apparatus of the extruder head may be configured to shape the extruded cementitious composition into a desired cross-sectional shape on the extrusion platform. For example, the mold apparatus can be configured to form the cementitious composition into a rectangular cross-section. A lower surface of the mold apparatus may comprise one or more dividers configured to form the cementitious composition into strips of desired width and thickness. In some embodiments, the extruder head may be configured to shape the extruded cementitious composition into a desired cross-sectional shape on an extrusion substrate (e.g., polystyrene mold or product core) positioned on the extrusion platform to form lightweight architectural cementitious products, such as crown molding, trim, or other strips having a defined three-dimensional shape along a longitudinal axis.

The cementitious strips and other shapes can be cut, such as while in a wet and uncured state, into individual thin bricks or other linear architectural products of desired length. Alternatively, the mold apparatus may be free of dividers such that the cementitious composition is formed into a single strip or other shape of desired width and thickness, which can be cut to form cementitious products of desired length.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the present disclosure will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 illustrates a flow diagram of a process for manufacturing architectural cementitious products using a conveyor and extrusion system.

FIG. 2 illustrates an embodiment of an extruder head configured to form a continuous sheet of cementitious material.

FIG. 3 illustrates another embodiment of an extruder head, according to an implementation of the present disclosure.

FIG. 4A illustrates another embodiment of an extruder head, according to an implementation of the present disclosure.

FIG. 4B illustrates a lower perspective view of the extruder head shown in FIG. 4B.

FIG. 5 illustrates another embodiment of an extruder head having multiple independently fed extrusion channels.

FIG. 6A illustrates a conveyance system including a transmission chain and drive components.

FIG. 6B illustrates the conveyance system of FIG. 6A with an extrusion platform engaged with the transmission chain.

FIG. 7 illustrates another embodiment of a conveyance system including pinions configured to engage linear racks of the extrusion platforms.

FIG. 8 illustrates an embodiment of an extrusion platform, according to an implementation of the present disclosure.

FIG. 9 illustrates a magnified view of adjacent example extrusion platforms showing alignment and engagement of linear racks.

FIG. 10A illustrates another embodiment of an extrusion platform, according to an implementation of the present disclosure.

FIG. 10B illustrates a detailed view of a lower surface of the extrusion platform shown in FIG. 10A.

FIG. 11 illustrates an embodiment of a conveyor and extrusion system, including an extruder head and a conveyance system, in a combined configuration.

FIG. 12 illustrates a cross-sectional view of an extruder head configured to form a cementitious composition into parallel strips.

FIG. 13 illustrates an embodiment of extruded cementitious strips formed according to the shape of an extrusion channel.

FIG. 14 illustrates an embodiment of an extrusion platform supporting a plurality of extrusion substrates.

FIG. 15 illustrates an embodiment of cementitious products formed over the extrusion substrates.

FIG. 16 illustrates an extrusion platform and substrate arrangement for supporting a plurality of extrusion substrates during the formation of architectural cementitious products.

FIG. 17A illustrates an example mold apparatus having a contoured cross-section for forming a shaped architectural cementitious product.

FIG. 17B illustrates an example cementitious product formed using the contoured mold of FIG. 17A.

FIG. 18A illustrates a cutting system or subsystem that include a cutting mechanism in a first position relative to extruded cementitious compositions on a conveyer of the conveyance system or subsystem.

FIG. 18B illustrates the conveyance system of FIG. 18A after cutting the extruded cementitious compositions.

FIG. 19A illustrates another embodiment of a cutting mechanism configured to cut a continuous sheet of cementitious material.

FIG. 19B illustrates the cutting mechanism of FIG. 19A after forming cuts in the continuous sheet.

FIG. 20 illustrates a flowchart of an exemplary method for manufacturing cementitious products.

### DETAILED DESCRIPTION

### Introduction

Disclosed are conveyor and extrusion systems, processes, and methods for manufacturing architectural cementitious products having a desired shape from a cementitious composition. In some embodiments, a conveyor and extrusion system includes a mixing system, a pumping system, an extruding system, a conveyance system, and optionally cutting and/or drying systems. For example, an extruder head can extrude cementitious material onto an extrusion platform (and optionally one or more extrusion substrates disposed thereon), and a conveyance system configured to reliably support, carry, and maintain the extrusion platform in a desired position and movement relative to the extruder head can move the extruded cementitious material to downstream processes such as cutting and/or drying (in either order). In some embodiments, the conveyor and extrusion systems may be configured for manufacturing thin brick. Alternatively, they may be configured to form other types of architectural products, non-limiting examples of which are disclosed herein.

Bricks are common construction products that have been used since nearly the beginning of human history. In modern times, bricks are often produced by an automated industrial process, reducing manual labor and improving the uniformity of brick products (e.g., in appearance and strength). These processes have provided increased production and efficiency in brick manufacturing. Bricks are typically made by forming a moldable clay material into desired shapes and firing the green bodies in a kiln to solidify them into fired bricks. Alternatively, bricks can be made by molding a cementitious composition into green bodies and allowing the green bodies to harden or cure to form hardened cementitious bricks.

The conveyor and extrusion systems and methods disclosed herein can facilitate controlled manufacture of architectural cementitious products according to particular project requirements, which can have an almost endless variety of colors and/or textures having a desired look, providing greater control to the manufacturer over the design and appearance of the architectural products. The conveyor and extrusion systems and methods also enable the production of architectural products at higher speeds and under controlled conditions. The conveyor and extrusion systems and methods can facilitate uniformity in the size, shape, and/or appearance of the cementitious products.

### Definitions

The term “cementitious composition” refers to a cement-based mixture having a fluidity and viscosity sufficient to allow the mixture to be pumped through tubing or piping and to be extruded through an extruder head shaped by a mold. The material attributes of the mixture allow the cementitious composition to be form stable in a green state and generally retain its shape after being formed by the extrusion system.

The terms “cementitious product” and “cementitious material” refer to the cementitious composition after it has been formed and shaped by the extrusion system, and which are configured for removal from the extrusion platform of the system. The cementitious products may comprise a substrate (e.g., polystyrene foam core) over which the cementitious composition has been applied and hardened.

The term “substrate” may refer to materials on or forming a part of the extrusion platform having a surface configured to be coated with the cementitious composition. An “extrusion substrate” may refer to a substrate that is distinct and separate from the extrusion platform and which, in some instances, may form a part of the finished cementitious product. A non-limiting example can include a foam or rubber material placed first onto an extrusion platform, whereon a cementitious product may be extruded to form architectural cementitious products having a lightweight foam or rubber core or layer.

The terms “upstream” and “downstream” refer to relative positions along the conveyance system. Materials disposed upstream can be configured to be carried in a direction downstream by the conveyance system, or components of the conveyance system disposed upstream may be configured to convey materials to downstream components of the conveyance system. The term “forward” may refer to a generally downstream direction.

### Cementitious Compositions

The cementitious composition may be formulated to include: 1) a cementitious binder component, 2) an aggregate component, preferably including at least two types and/or gradations of aggregate (e.g., limestone and/or silica aggregates), and 3) one or more admixtures selected from water reducers, flow modifiers, retarders, viscosity modifiers, adhesives, sealants, strength enhancers, dyes, and colorants. These are mixed with water to form a fresh cementitious composition that is in a plastic or flowable state for application to the surface. Examples of extrudable cementitious compositions are disclosed in U.S. Patent Publication No. 2023/0364825, U.S. Provisional Application No. 63/844,282, filed Jul. 15, 2025, for “Extrudable Cementitious Composition And Method For Manufacturing Cementitious Architectural Products,” and U.S. Provisional Application No. 63/996,643, filed Mar. 4, 2026, for “Extrudable Cementitious Composition And Method For Manufacturing Cementitious Architectural Products,” which are incorporated by reference.

The fresh cementitious composition may be applied to the extrusion platform and optional substrate and then caused or allowed to harden or cure. The cementitious composition can optionally be cut while in a green state (e.g., within 1 minute to 6 hours, or 5 minutes to 3 hours, or 10 minutes to 2 hours), after partially hardening (e.g., within 12-24 hours), or after hardening (e.g., after 24 hours). In preferred embodiments, the fresh cementitious composition is free of chemically or thermally curable organic binders, such as epoxy resins and hardeners, in order for the cementitious binder to be the primary or sole binder.

The cementitious binder component is preferably white Portland cement. Although some embodiments may include ordinary (grey) Portland cement, the cementitious binder component is preferably 50% or more, 60% or more, 75% or more, or 90% or more, or 95% or more, or about 100% white Portland cement. A supplementary cementitious material may optionally be included, examples of which include fly ash, ground granulated blast furnace slag (GGBFS), metakaolin, silica fume, pumice, volcanic ash, ground glass, and natural pozzolan. The cementitious binder component may constitute about 15% to 45%, or more preferably about 20% to 40% (e.g., about 25% to 35%) of the weight of the cementitious composition (excluding water).

The aggregate component may constitute about 50% to about 80%, or about 55% to about 75%, or about 60% to about 70%, or about 65.3%, by weight of the cementitious composition (excluding water). The aggregate component preferably includes at least two gradations of aggregate material (e.g., to provide desired rheology or other performance characteristics when in fresh state and/or desired aesthetic or other performance characteristics when in a hardened state. In some embodiments, the cementitious composition may be formulated so as to produce cementitious products that closely resemble the appearance of real cut stone. Such formulations may include a fine sand and a coarse sand in the aggregate component of the cementitious composition. In some embodiments, cementitious compositions may include coarse sand, medium sand, and fine sand (filler).

The aggregate may include one or more gradations of limestone, one or more gradations of silica, or a combination thereof. Limestone is softer than silica and may be easier to sand (in cases where sanding is performed). Silica may provide a more defined crystal structure and greater strength. An aggregate may include, for example, a fine limestone and/or silica portion, a medium limestone and/or silica portion, and a coarse limestone and/or silica portion.

In some embodiments, the coarse sand component can have a D90 in a range of about 1.25 mm to about 3.25 mm, or about 1.5 mm to about 2.75 mm, or about 1.75 mm to about 2.25 mm and/or a D50 in a range of about 0.75 mm to about 2.25 mm, or about 1 mm to about 2 mm, or about 1.25 mm to about 1.75 mm and/or a D10 in a range of about 0.5 mm to about 1.5 mm, or about 0.65 mm to about 1.35 mm, or about 0.8 mm to about 1.2 mm. In some embodiments, the extrudable cementitious composition may comprise about 20% to about 35%, or about 22.5% to about 32.5%, or about 25% to about 30%, or about 27%, by weight of the coarse sand, excluding water.

In some embodiments, the medium sand component can have a D90 in a range of about 0.35 mm to about 1.25 mm, or about 0.5 mm to about 1 mm, or about 0.6 mm to about 0.9 mm and/or a D50 in a range of about 0.25 mm to about 0.6 mm, or about 0.3 mm to about 0.5 mm, or about 0.35 mm to about 0.45 mm and/or a D10 in a range of about 0.08 mm to about 0.2 mm, or about 0.09 mm to about 0.175 mm, or about 0.1 mm to about 0.15 mm. In some embodiments, the extrudable cementitious composition may comprise about 15% to about 30%, or about 17.5% to about 27.5%, or about 20% to about 25%, or about 22.7%, by weight of the medium sand, excluding water.

In some embodiments, fine sand component, which may be considered to be a mineral filler, can have a D90 in a range of about 0.075 mm to about 0.35 mm, or about 0.1 mm to about 0.25 mm, or about 0.125 mm to about 0.25 mm and/or a D50 in a range of about 0.035 mm to about 0.125 mm, or about 0.045 mm to about 1 mm, or about 0.5 mm to about 0.85 mm. In some embodiments, the extrudable cementitious composition may comprise about 10% to about 25%, or about 12% to about 20%, or about 14% to about 17.5%, or about 15.6%, by weight of the fine sand, excluding water.

Cementitious compositions having aggregates with such fine, medium, and coarse sand portions have been found to be effective in providing the appearance of cut stone. The fine sand portion enables effective application and facilitates even coverage of the cementitious composition on the extrusion platform and optional substrate. At the same time, the medium and coarse sand portions may provide visible crystal facets that can be exposed by finishing (e.g., sanding and/or polishing) of the treated surface.

The cementitious composition may further include various admixtures, as discussed above, in appropriate quantities to impart desired properties while the cementitious composition is in a wet and flowable state and also when it hardens or cures.

### Conveyor And Extrusion System

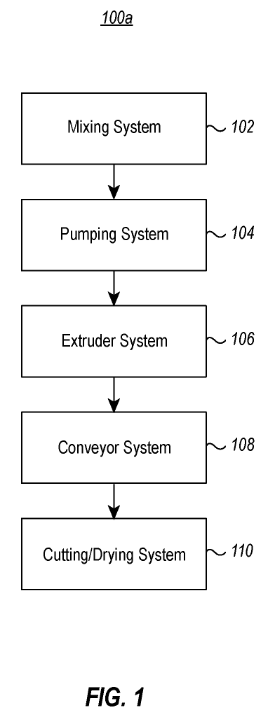

Referring now to the Figures, FIG. 1 illustrates an overall conveyor and extrusion system 100a for manufacturing architectural cementitious products. The system 100a may include a mixing system 102, a pumping system 104, an extruder system 106, a conveyor system 108, and optionally a cutting and/or drying system 110.

The mixing system 102 may be configured to combine one or more cementitious binders, aggregates, water, and optional admixtures to produce a fresh cementitious composition having a desired consistency and flowability. The mixing system 102 may include one or more mixers, hoppers, or batching components configured to prepare the fresh cementitious composition for downstream processing.

The pumping system 104 may be configured to transfer the fresh cementitious composition from the mixing system 102 to the extruder system 106. In some embodiments, the pumping system 104 may include one or more pumps, hoses, or conduits known in the art and configured to deliver the fresh cementitious composition under pressure to one or more extruder heads.

FIG. 1 shows that the extruder system 106 may be configured to receive the fresh cementitious composition and form it into a desired shape. For example, the extruder system 106 may include one or more extruder heads having a manifold and a mold apparatus configured to shape the fresh cementitious composition into strips, sheets, or other desired profiles.

The conveyor system 108 may be configured to support, carry, and move one or more extrusion platforms relative to the extruder system 106. The conveyor system 108 may include one or more conveyance mechanisms, such as belts, chains, rollers, or pinion-driven systems, configured to control the position, alignment, and speed of the extrusion platforms during the extrusion process. Though not illustrated, the conveyor system 108 may start before (e.g., upstream of) the extruder system 106, be present underneath or adjacent to the extruder system 106, and may continue past (e.g., downstream of) the extruder system 106. In this manner, the conveyor system 108 may be configured to transport one or more extrusion platforms to a position beneath an extruder head, carry the extrusion platforms beneath the extruder head during deposition of the fresh cementitious composition, and further convey the extrusion platforms with the deposited cementitious composition downstream for additional processing.

The optional cutting and/or drying system 110 may be configured to further process the extruded cementitious composition and/or products made therefrom. For example, the cutting system may be configured to cut the extruded cementitious composition into discrete products of desired dimensions, and the drying system may be configured to cause allow the cementitious composition to harden and/or cure under controlled conditions. The drying system may include a curing chamber of controlled temperature and humidity. In some embodiments, the cutting and/or drying system 110 may be a separate system to which the extruded cementitious composition is carried or transferred, such as to a dedicated curing chamber or drying area. In other embodiments, the cutting and/or drying system 110 may be positioned in-line with the extruder system 106 and conveyor system 108 such that the extruded cementitious composition is processed without removal from the conveyance path.

The systems and components illustrated in FIG. 1 are provided for purposes of illustration and may be used in various combinations and configurations. One or more components can be omitted, and one or more components not shown can be added. The following description sets forth various embodiments of the mixing system 102, pumping system 104, extruder system 106, conveyor system 108, and cutting and/or drying system 110, and it will be appreciated that such components may be combined, omitted, or modified without limitation depending on the desired application or manufacturing process.

### Extruder Systems and Extruder Heads

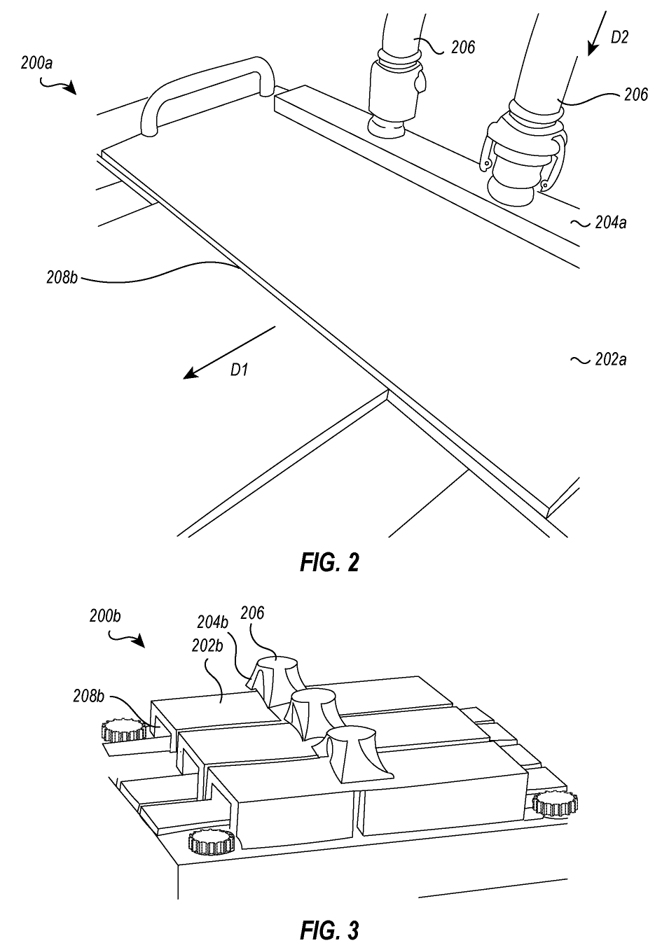

Turning now to FIGS. 2-5, various embodiments of extruder systems are illustrated, such as the generic extruder system 106 introduced in FIG. 1. The illustrated embodiments provide examples of extruder heads, manifolds, and mold apparatuses configured to receive a cementitious composition and form the cementitious composition into one or more desired shapes. While specific configurations are shown and described, it will be appreciated that the features of the extruder systems illustrated in FIGS. 2-5 may be used individually or in any combination with one another, and in conjunction with any of the other systems described herein, without limitation.

FIG. 2 illustrates an embodiment of an extruder head 200a configured to form a continuous sheet of extruded cementitious material. The extruder head 200a may include a mold apparatus 202a, a manifold 204a, one or more inlets 206, and an extrusion channel 208a. In the illustrated embodiment, the extrusion channel 208a is configured to produce a substantially flat and continuous sheet of extruded cementitious composition as the material exits the extruder head 200a.

The manifold 204a may define an internal chamber configured to receive and temporarily hold the fresh cementitious composition delivered through the one or more inlets 206 (e.g., in direction D2). In this manner, the manifold 204a may function as a buffer or distribution chamber that promotes a more uniform flow of fresh cementitious material into the extrusion channel 208a. The manifold 204a may extend across a width that corresponds to, exceeds, or is less than a width of the extrusion channel 208a to facilitate even distribution of the fresh cementitious composition prior to extrusion. As shown, manifold 204a may be relatively compact in volume, which can be advantageous for reducing the amount of fresh cementitious composition required to fill the manifold during operation while still maintaining a desired throughput. The volume of the manifold 204a may be similar to, less than, or greater than a volume defined by the mold apparatus 202a, depending on the desired flow characteristics and material buffering requirements of the extrusion process.

The extrusion channel 208a may be defined by the mold apparatus 202a, extend from the manifold 204a, and be configured to shape the fresh cementitious composition into a desired cross-sectional profile. In the embodiment shown, the extrusion channel 208a is substantially planar to form a continuous sheet; however, the geometry of the extrusion channel 208a may be varied to achieve different widths, thicknesses, and profiles of the extruded cementitious composition. For example, the extrusion channel 208a may be configured to control the height and width of the extruded cementitious sheet within selected ranges depending on the desired end product. In some embodiments, the extrusion channel 208a and/or mold apparatus 202a may include shaped surfaces, tapered regions, or flow-directing structures that promote uniform flow, reduce voids, and improve the dimensional consistency of the extruded cementitious material.

During operation, the fresh cementitious composition may be delivered through the inlet 206 into the manifold 204a and then directed through the extrusion channel 208a, where it is shaped and discharged as a continuous extruded cementitious sheet. As an extrusion platform is conveyed relative to the extruder head 200a, the continuous sheet of fresh extruded cementitious composition may be deposited onto the extrusion platform and carried downstream for further processing. In some embodiments, the extruder head 200a and/or one or more associated components may include a vibration mechanism configured to impart vibration to the cementitious composition during extrusion. The vibration may reduce yield stress, improve flowability, promote consolidation of the fresh extruded cementitious composition, and facilitate removal of entrapped air, thereby improving uniformity and surface quality of the extruded cementitious sheet.

It will be appreciated that the embodiment of FIG. 2 represents one example of an extruder head configured to form a continuous sheet of fresh cementitious composition, and that various modifications may be made to the configuration of the manifold 204a, inlet 206, extrusion channel 208a, and mold apparatus 202a without departing from the scope of the present disclosure.

FIG. 3 illustrates another embodiment of an extruder head 200b, which may include components similar to those described with respect to extruder head 200a, but configured to produce multiple discrete strips of extruded cementitious material rather than a single continuous cementitious sheet. The extruder head 200b may include a plurality of mold apparatuses 202b, manifolds 204b, inlets 206, and extrusion channels 208b arranged adjacent to one another. In this embodiment, each manifold 204b may be configured to receive fresh cementitious composition from a corresponding inlet 206 and to supply the cementitious material to a corresponding extrusion channel 208b. Each extrusion channel 208b may be shaped by a corresponding mold apparatus 202b to form a discrete strip of fresh cementitious material. As a result, the extruder head 200b may be configured to simultaneously form a plurality of parallel cementitious strips rather than a single continuous cementitious sheet.

Providing separate manifolds 204b and associated components for each extrusion channel 208b may allow the flow characteristics of each cementitious strip to be independently controlled. For example, the flow rate, pressure, or composition delivered to each extrusion channel 208b may be adjusted without affecting adjacent channels. This configuration may also reduce the volume of fresh cementitious material held within any single manifold at a given time, thereby further limiting the amount of cementitious material residing within the extruder head prior to extrusion.

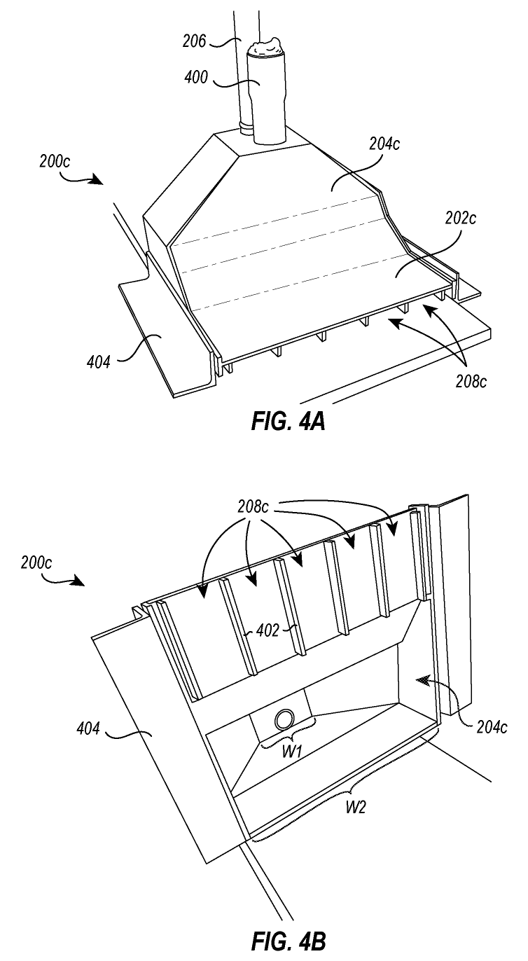

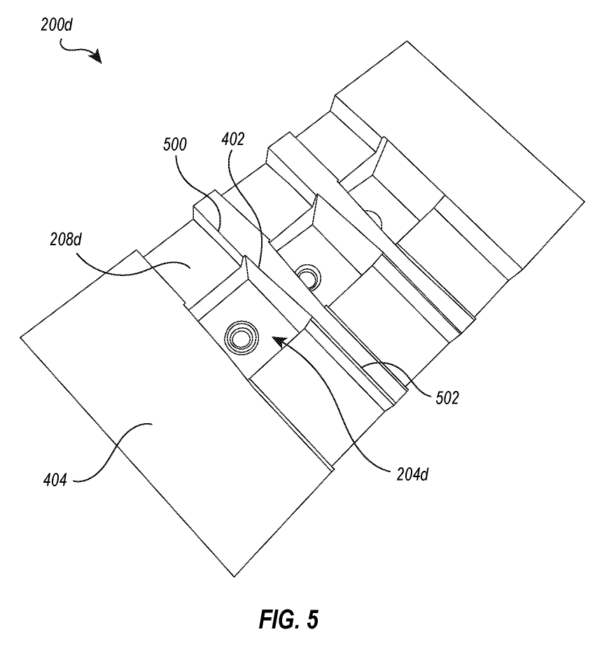

FIG. 4A illustrates another embodiment of an extruder head 200c, which may be configured to produce a plurality of discrete extruded cementitious strips similar to extruder head 200b, but utilizing a shared cementitious material distribution system. The extruder head 200c may include a mold apparatus 202c, a manifold 204c, an inlet 206, and a plurality of extrusion channels 208c extending from the manifold 204c. In this embodiment, the manifold 204c may define a common internal chamber configured to receive fresh cementitious composition from the inlet 206 and distribute the cementitious composition to each of the plurality of extrusion channels 208c. Each extrusion channel 208c may be defined by the mold apparatus 202c and configured to form a corresponding strip of fresh cementitious material, such that the extruder head 200c produces a plurality of parallel cementitious strips from a shared material source. The manifold 204c may have a relatively larger internal volume compared to the mold apparatus 202c and associated extrusion channels 208c. In some embodiments, the volume is less than or substantially equal to the volume of mold apparatus 202c. This increased volume may advantageously act as a cementitious material reservoir and promote more consistent flow of cementitious material across the plurality of extrusion channels 208c. In some embodiments, the volume of fresh cementitious composition contained within the manifold 204c may contribute to maintaining pressure at the extrusion channels 208c, thereby assisting in driving fresh cementitious material through the mold apparatus 202c. This configuration may improve uniformity across the extrusions and reduce fluctuations in flow rate between adjacent channels.

In some embodiments, the extruder head 200c may further include an outlet or overflow nozzle 400 in fluid communication with the manifold 204c. The outlet nozzle 400 may be configured to allow entrapped air and/or excess cementitious composition to exit the manifold 204c in the event that cementitious material is supplied to the inlet 206 at a rate exceeding the capacity of the extrusion channels 208c. This may help regulate internal pressure within the manifold 204c and reduce potential defects associated with over-pressurization or air entrapment.

FIG. 4B illustrates a cross-sectional view of the extruder head 200c. As shown, a plurality of walls 402 may define the individual extrusion channels 208c. The walls 402, in combination with the inner surfaces of the extrusion channels 208c and the surface of an extrusion platform positioned beneath the extruder head 200c, may define the cross-sectional geometry of the extruded cementitious material. The walls 402 may be substantially linear and arranged to maintain separation between adjacent extrusion channels 208c, thereby facilitating the formation of discrete strips of cementitious material rather than a continuous sheet. While five extrusion channels 208c are illustrated, it will be appreciated that any suitable number of extrusion channels may be provided, including, for example, one, two, three, four, six, seven, eight, or more channels, depending on the desired output.

FIG. 4B also illustrates one or more brackets 404 positioned on opposing sides of the extruder head 200c. The brackets 404 may be configured to facilitate mounting of the extruder head 200c to a support structure, such as a frame of a conveyor system, or to otherwise position the extruder head 200c above an extrusion platform during operation. In some embodiments, the support structure may be adjustable to permit selective positioning of the extruder head 200c, including adjustment of height, tilt, and lateral alignment relative to the extrusion platform

It will be appreciated that the embodiment of FIG. 4A and 4B provides an alternative configuration in which multiple extrusion channels are supplied from a shared manifold, and that features of this embodiment may be combined with those of FIGS. 2 and 3 or otherwise modified without limitation.

FIG. 5 illustrates another embodiment of an extruder head 200d, which may include components similar to those described in previous embodiments, including mounting brackets 404 and a plurality of manifolds 204d. In this embodiment, the extruder head 200d may include a plurality of extrusion channels 208d defined by corresponding walls 402, where each extrusion channel 208d is associated with a respective manifold 204d.

In contrast to previously described embodiments, the walls 402 defining the extrusion channels 208d may be angled or non-parallel relative to one another. For example, an upstream end 502 of an extrusion channel 208d may have a larger cross-sectional dimension than a downstream end 500 of the extrusion channel 208d. This tapered or converging geometry may assist in directing and consolidating the fresh cementitious composition as it flows through the extrusion channel 208d, which may improve flow uniformity, reduce voids, and enhance the dimensional consistency of the extruded cementitious material. In some embodiments, the extrusion channels 208d may be sized to accommodate an underlying substrate or core material positioned on an extrusion platform beneath the extruder head 200d. For example, the extrusion channels 208d may be oversized relative to the final desired cementitious layer thickness to allow a fresh cementitious composition to be deposited over and around one or more substrates. This configuration may facilitate the formation of a cementitious coating or shell over the substrate, thereby producing composite architectural products having a core material and an exterior cementitious layer. It will be appreciated that the angled geometry of the extrusion channels 208d may be combined with other features described herein, including vibration mechanisms, adjustable mounting, and flow control, without limitation.

### Conveyor Systems and Extrusion Platforms

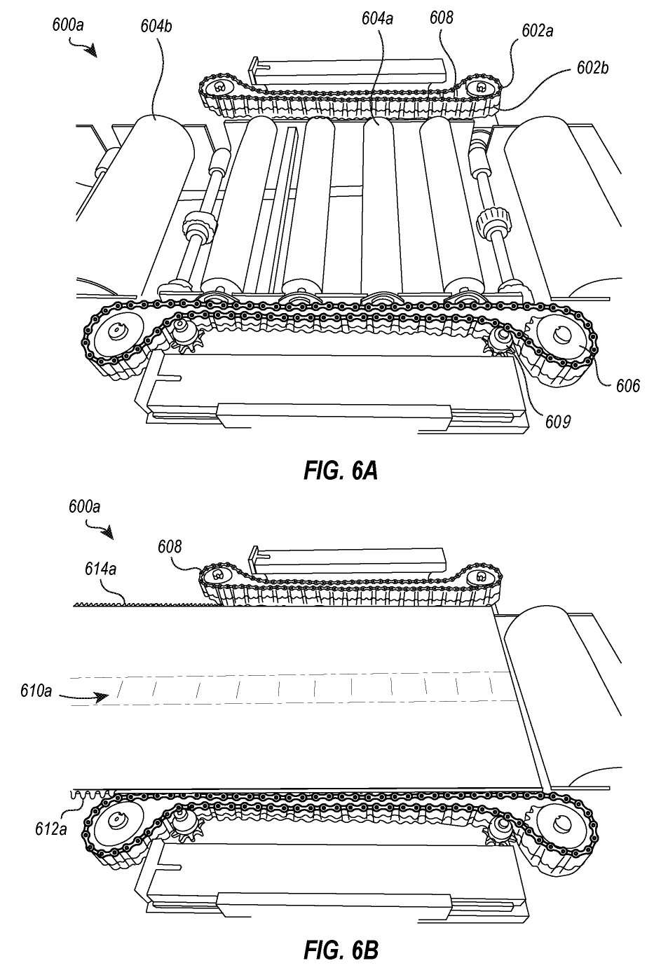

Turning now to FIGS. 6A-10B, various embodiments of conveyor systems and extrusion platforms are illustrated, along with their interaction with one another and with the extruder systems described above. The illustrated embodiments provide examples of mechanisms for supporting, aligning, and conveying one or more extrusion platforms relative to an extruder head and optional cutting/drying system during operation. While specific configurations are shown, it will be appreciated that the features of the conveyor systems and extrusion platforms described in FIGS. 6A-10B may be used individually or in any combination with one another, and in conjunction with any of the conveyor and extruder systems described herein, without limitation.

FIG. 6A illustrates an embodiment of a conveyor system 600a configured to convey one or more extrusion platforms relative to an extruder system. The conveyor system 600a may include a transmission chain 608 configured to define a conveyance path along which an extrusion platform may travel. The transmission chain 608 may include a plurality of linkage series, including a first linkage series 602a and a second linkage series 602b. The linkage series 602a and 602b may be arranged adjacent to one another, such as in a stacked or side-by-side configuration, to define a continuous engagement structure along the conveyor system 600a.

In some embodiments, the transmission chain 608 may be configured to engage a corresponding engagement feature of an extrusion platform, such as a rack or series of teeth, to not only drive the extrusion platform along the conveyance path but also to maintain the extrusion platform in a fixed vertical position relative to the conveyor system 600a. The use of transmission chain 608 may limit or prevent upward and downward movement (relative to the extruder head). This controlled positioning may improve alignment, reduce vibration-induced variation, and enhance the overall quality and uniformity of the extruded cementitious material.

The conveyor system 600a may further include one or more drive gears 606 configured to engage and drive the transmission chain 608. The drive gears 606 may be connected to a motor or other actuation mechanism to facilitate controlled movement of the transmission chain 608 along the conveyance path. In some embodiments, the conveyor system 600a may include one or more tensioning gears, wheels, or other tensioning means 609 configured to adjust the tension of the transmission chain 608. The tensioning means 609 may be adjustable to facilitate installation, removal, or replacement of the transmission chain 608 and to maintain proper engagement between the chain and associated components during operation.

FIG. 6A also illustrates that the conveyor system 600a may also include a plurality of rollers, such as first rollers 604a and second rollers 604b, positioned along the conveyance path. The rollers 604a and 604b may support an extrusion platform and facilitate movement of the extrusion platform along the conveyor system 600a. In some embodiments, the rollers 604a and 604b may be powered or unpowered and may be configured with selected diameters or spacing to accommodate different load or conveyance requirements. For example, selected rollers may have larger diameters to provide increased support, load-bearing capacity, or suspension, while other rollers may have smaller diameters to accommodate space constraints or to provide more precise positioning and control of the extrusion platform along the conveyance path.

FIG. 6B illustrates the conveyor system 600a of FIG. 6A in combination with an extrusion platform 610a positioned thereon. The extrusion platform 610a may include one or more engagement features, such as a linear rack 614a having a plurality of teeth 612a, configured to engage the transmission chain 608. In the illustrated embodiment, the transmission chain 608 may interface with the teeth 612a of the linear rack 614a to drive the extrusion platform 610a along the conveyance path. The engagement between the transmission chain 608 and the linear rack 614a may facilitate controlled longitudinal movement of the extrusion platform 610a while maintaining alignment with the conveyor system 600a. In some embodiments, the engagement between the transmission chain 608 and the linear rack 614a may also restrict vertical movement of the extrusion platform 610a relative to the conveyor system 600a (e.g., to prevent up and down movements to ensure proper height of extruded cementitious products). It will be appreciated that the configuration illustrated in FIG. 6B represents one example of interaction between a conveyor system and an extrusion platform, and that various modifications may be made to the engagement features, positioning, and components without departing from the scope of the present disclosure.

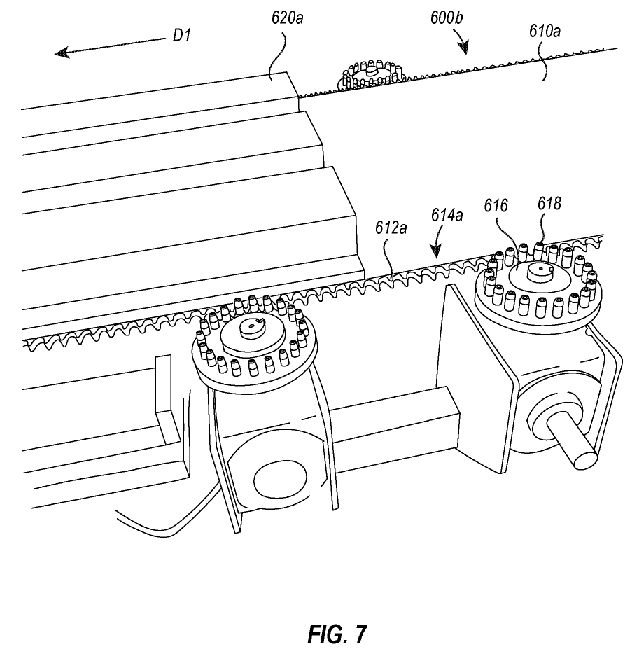

FIG. 7 illustrates another embodiment or subcomponent of a conveyor system 600b in combination with an extrusion platform 610a. The conveyor system 600b may include one or more pinions 616 configured to engage corresponding engagement features of the extrusion platform 610a. For example, the pinions may be oriented to rotate horizontally as illustrated. In the illustrated embodiment, the extrusion platform 610a may include one or more linear racks 614a having a plurality of teeth 612a positioned along one or more edges of the extrusion platform 610a. The teeth 612a may be configured to interface with corresponding engagement features of the pinions 616. This embodiment can be used for conveyance of extrusion platforms 610a upstream from the extrusion system and combined with the embodiment or subcomponent of a conveyor systems 600a and 600b shown in FIGS. 6A and 6B for conveying extrusion platforms 610a underneath the extruder head(s). Because the pinions permit vertical movement of the extrusion platform 610a, this embodiment permits an extrusion platform 610a to be lowered horizontally down to engage the pinions 616 when initially placing extrusion platforms 610a on the conveyor system upstream from the extrusion system. The extrusion platforms 610a can be fed from the conveyor system 600b to the conveyor system 600a to prevent the extrusion platforms 610a from up and down movement during extrusion of the cementitious composition thereon.

As shown, each pinion 616 may include a plurality of engagement elements, such as posts 618, which may function as teeth extending from the pinion 616. The posts 618 may be configured to engage the teeth 612a of the linear rack 614a to drive the extrusion platform 610a along the conveyor system 600b. In some embodiments, the posts 618 and the corresponding teeth 612a may have complementary shapes, such as rounded or curved profiles, to promote smoother engagement between the pinions 616 and the linear racks 614a. This configuration may reduce slippage, minimize wear, and provide more continuous and controlled movement of the extrusion platform 610a.

As further illustrated, one or more extrusion substrates 620a may be positioned on the extrusion platform 610a. The extrusion substrates 620a may be configured to receive a fresh cementitious composition deposited thereon, such that the extrusion process may form an extruded cementitious layer over the extrusion substrates 620a. It will be appreciated that the configuration of the conveyor system 600b and extrusion platform 610a may be modified as desired and may be used in combination with any of the systems described herein.

In some embodiments, different types of conveyor systems may be used in combination at different locations along a conveyance path. For example, a first conveyor system, such as the pinion-driven system 600b, may be used at an upstream or downstream location to facilitate loading, unloading, alignment, and initial conveyance of one or more extrusion platforms. A second conveyor system, such as the chain-driven system 600a, may be used at or near an extruder head to provide more controlled movement of the extrusion platforms. The chain-driven system 600a may be particularly advantageous in such locations due to its ability to engage the extrusion platform in a manner that restricts upward and downward movement, thereby maintaining a more consistent vertical position relative to the extruder head. This controlled positioning may improve alignment, extrusion consistency, and overall product quality. In some embodiments, extrusion platforms may be transferred between different conveyor systems along the conveyance path, such that the systems operate sequentially or as part of a modular arrangement. It will be appreciated that various combinations and arrangements of conveyor systems may be employed without limitation, depending on the desired application.

The system of the present disclosure may be modular, such that multiple conveyor systems and/or extruder systems can be arranged in series to form an integrated production line. For example, conveyor systems including belts, rollers, guides, or other conveyance components may be combined with one another, and one or more extruder heads may be positioned above or adjacent to selected portions of the conveyance path.

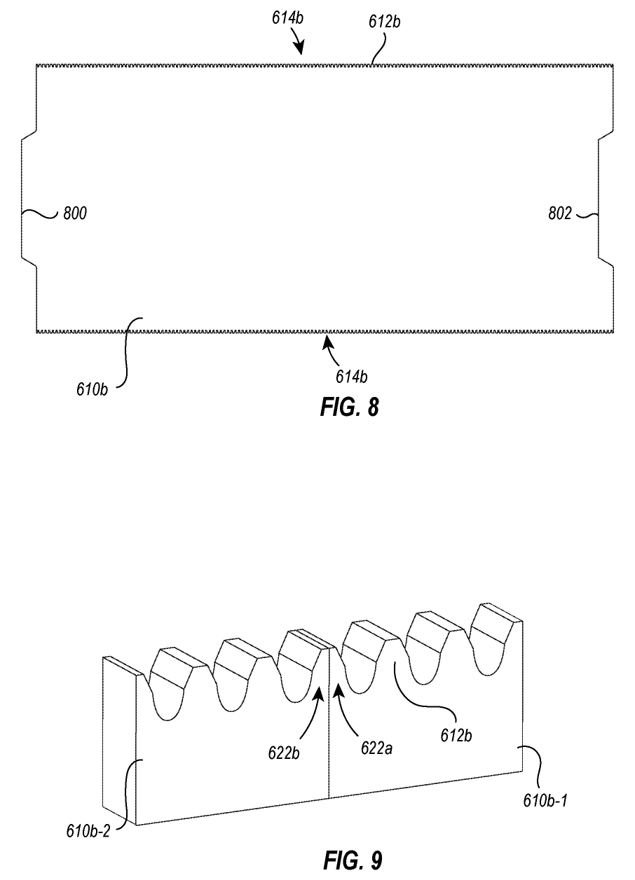

FIGS. 8 and 9 illustrate exemplary embodiments of extrusion platforms, such as extrusion platform 610b, 610b-1, and 610b-2, configured for use with the conveyor systems described herein. FIG. 8 illustrates an embodiment of an extrusion platform 610b configured for use with the conveyor systems described herein. The extrusion platform 610b may include a first edge that defines a notch 800 and an opposing edge that defines an index 802. The notch 800 and index 802 may be configured to interrelate with corresponding features of adjacent extrusion platforms to facilitate alignment and positioning of multiple extrusion platforms along a conveyance path. The extrusion platform 610b may further include one or more linear racks 614b positioned along opposing side edges of the extrusion platform 610b. Each linear rack 614b may include a plurality of teeth 612b configured to engage corresponding drive components, such as pinions or chain elements, to facilitate controlled movement of the extrusion platform 610b along a conveyor system.

In the illustrated embodiment, the teeth 612b may have a more angular or less rounded geometry compared to other embodiments described herein. However, it will be appreciated that the teeth 612b may have any suitable geometry, including rounded, square, triangular, or other profiles, depending on the desired engagement characteristics, wear properties, and manufacturing considerations.

The extrusion platform 610b may be formed from a variety of materials, including metal, wood, polymer, composite materials, or combinations thereof. In some embodiments, the linear racks 614b and associated teeth 612b may be integrally formed with the extrusion platform 610b or may be separate components attached thereto. For example, the linear racks 614b may be formed from a more wear-resistant material than the remainder of the extrusion platform 610b to improve durability during repeated engagement with drive components. In at least one embodiment, the linear rack may be a row or series of apertures formed int the surface of the extrusion platform. In some embodiments, the extrusion platform 610b may include a surface configured to receive a cementitious composition and to facilitate release of the cementitious composition after extrusion. The surface may be substantially flat or may include textures (grooves, recesses, protrusions, etc.), coatings, or treatments to influence the surface finish of the resulting cementitious product or to improve release characteristics.

For example, a release agent may be applied to the surface of the extrusion platform to facilitate removal of the cementitious products after drying or curing. In embodiments utilizing an extrusion substrate, the surface of the extrusion substrate may be pre-wetted and/or treated with an adhesion-promoting agent. Pre-wetting may include misting or spraying water or a water-based solution onto the surface. Such treatment may enhance bonding between the cementitious composition and the substrate and may reduce delamination or cracking of the resulting product.

FIG. 9 illustrates a magnified view of adjoining extrusion platforms, including a first extrusion platform 610b-1 and a second extrusion platform 610b-2, positioned in an end-to-end relationship. The extrusion platforms 610b-1 and 610b-2 may be configured to interrelate to form a continuous conveyance surface along a conveyor system. Though not illustrated, the notch of extrusion platform 610b-1 may be received by the index of extrusion platform 610b-2. As shown, each extrusion platform may include one or more linear racks having teeth configured to align with corresponding teeth of an adjacent extrusion platform.

For example, a first partial tooth 622a of the extrusion platform 610b-1 may be configured to align with a second partial tooth 622b of the extrusion platform 610b-2 to form a complete tooth when the extrusion platforms are positioned adjacent to one another. This alignment of partial teeth 622aand 622bmay facilitate continuous engagement between the extrusion platforms and a corresponding drive component, such as a pinion or transmission chain, as the extrusion platforms move along the conveyor system in a horizontal and linear direction. The formation of a complete tooth across adjacent extrusion platforms may reduce engagement discontinuities, thereby promoting smoother motion and minimizing vibration or misalignment during operation.

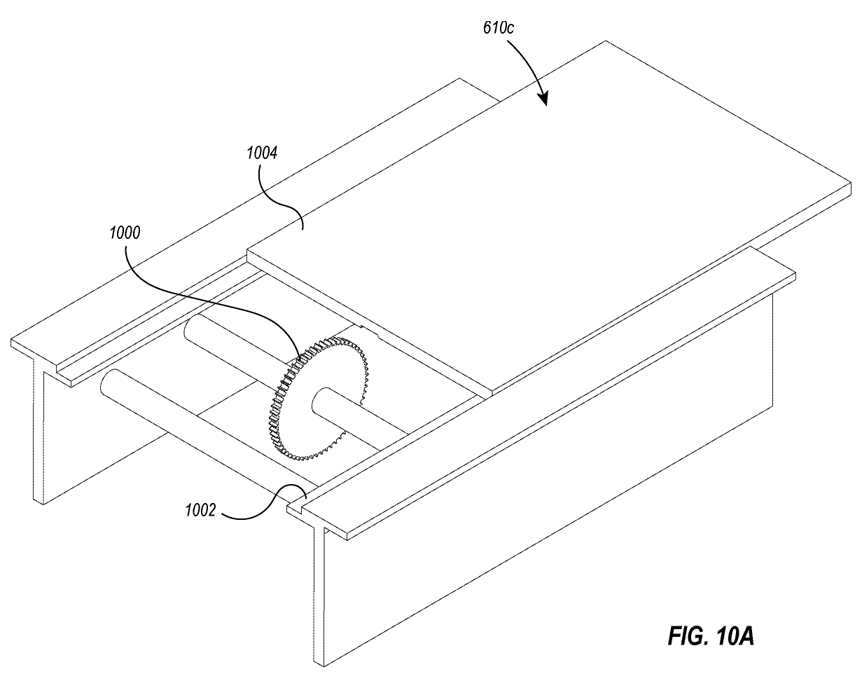

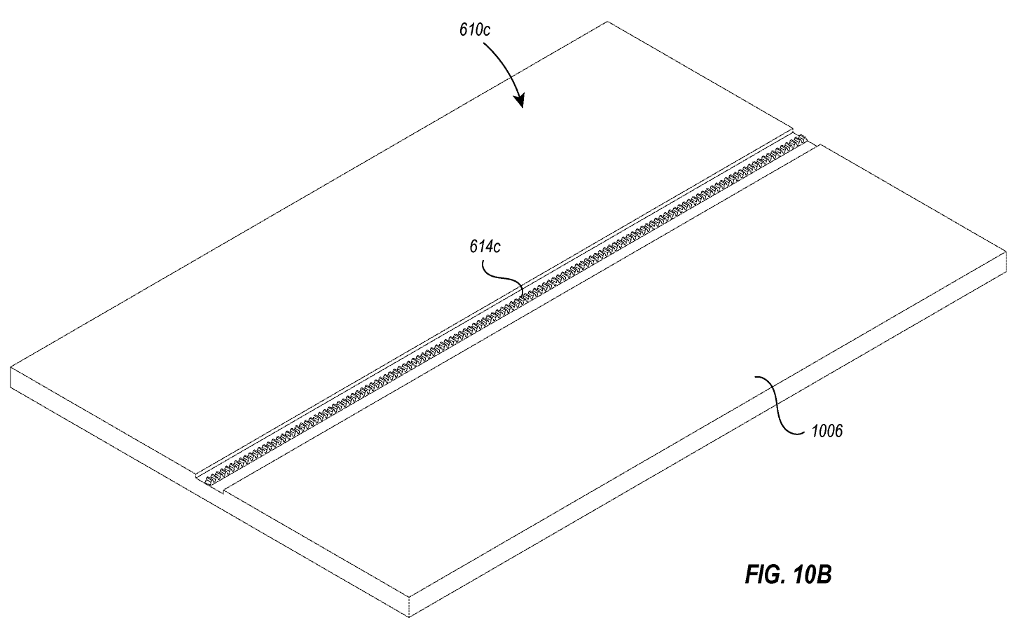

FIGS. 10A and 10B illustrate another embodiment of an extrusion platform 610c. The extrusion platform 610c may include a top surface 1004 configured to receive a cementitious composition during an extrusion process. The top surface 1004 may be substantially planar or may include selected textures, coatings, or treatments to influence adhesion, surface finish, or release characteristics of the cementitious material. As shown in FIG. 10A, the extrusion platform 610c may be configured to engage one or more drive components, such as pinions 1000, gears, chains, etc., which may be similar to those described in other embodiments. The pinions 1000 may be configured to interface with corresponding engagement features of the extrusion platform 610c, such as a rack or series of teeth positioned on a lower surface of the extrusion platform 610c, to drive the extrusion platform 610c along a conveyance path (see FIG. 10B).

The extrusion platform 610c may be supported and guided by one or more guide structures 1002, which may represent a frame or support system configured to maintain alignment of the extrusion platform 610c during operation. The guide structures 1002 may include rails, tracks, rollers, supports, or other structural elements that constrain the movement of the extrusion platform 610c to a desired path and orientation relative to an associated extruder head.

FIG. 10B illustrates a detailed view of the extrusion platform 610c, including a lower surface 1006 that may include one or more engagement features configured to interface with the pinions 1000. In some embodiments, the engagement features may include a linear rack 614c extending along a length of the extrusion platform 610c, which may be configured to engage the pinions 1000 to provide controlled movement of the extrusion platform 610c.

It will be appreciated that the embodiments shown in FIG. 6A-10B are example embodiments; the features described herein may be combined with other embodiments or modified without limitation.

### Extrusion System and Products

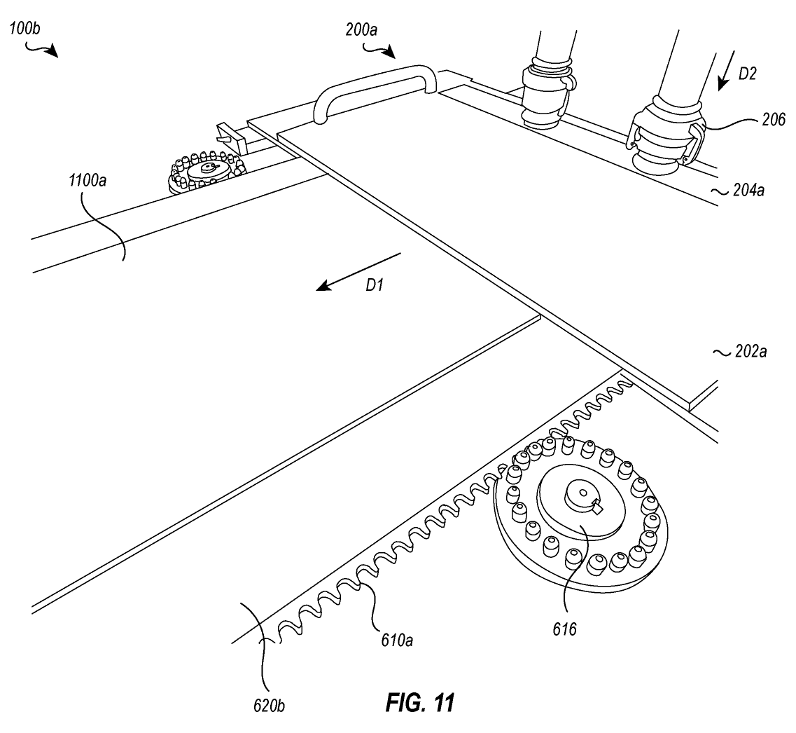

FIG. 11 illustrates a portion of an extrusion system 100b incorporating an extruder head and a conveyor system. As shown, the extrusion system 100b may include an extruder head 200a having a mold apparatus 202a, a manifold 204a, and one or more inlets 206 configured to receive a fresh cementitious composition. The fresh cementitious composition may be introduced into the manifold 204a (e.g., from a mixing system and/or pump system) in a direction D2 and may be distributed within the manifold 204a prior to being extruded through the mold apparatus 202a in a downstream direction D1. As the fresh cementitious composition exits the extruder head 200a, it may be formed into a continuous cementitious sheet 1100a. The continuous cementitious sheet 1100a may be deposited onto an extrusion platform 610a, which may be conveyed relative to the extruder head 200a by a conveyor system including one or more drive components, such as pinions 616. The extrusion platform 610a may carry one or more extrusion substrates 620b, such that the fresh cementitious composition may be deposited onto the extrusion substrates 620b to form an extruded cementitious layer thereon.

In some embodiments, the extrusion platform 610a may be loaded at an upstream location with one or more extrusion substrates 620b prior to being conveyed beneath the extruder head 200a. The loaded extrusion platform 610a may then be transported along the conveyor system to a position beneath the extruder head 200a for deposition of the fresh cementitious composition. After passing beneath the extruder head 200a, the extrusion platform 610a carrying the deposited cementitious composition and/or substrates 620b may continue downstream and be delivered to a cutting and/or drying system. In other embodiments, the extrusion platform 610a may be removed from the conveyor system at a downstream location and transferred, such as by lifting or repositioning, to a separate cutting or drying system for further processing.

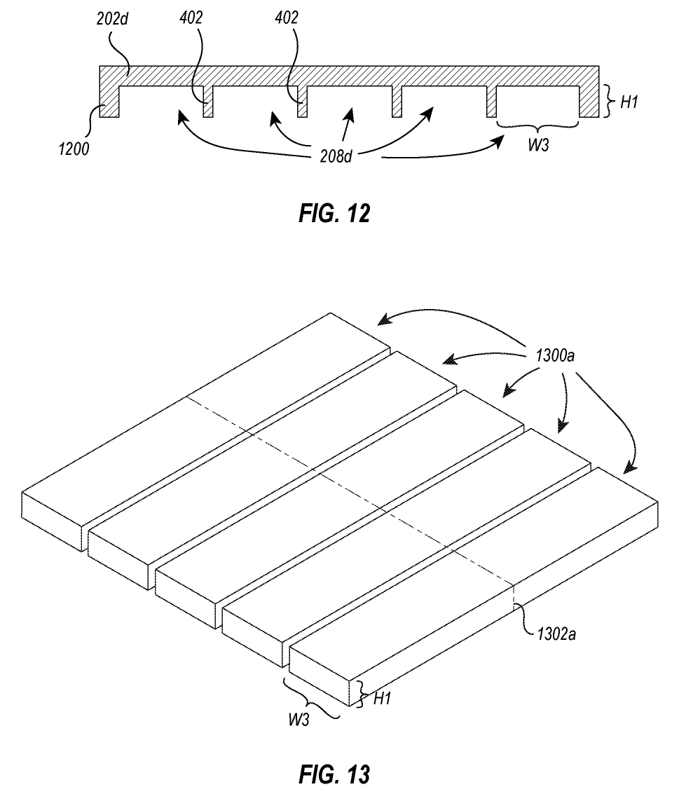

FIG. 12 illustrates a cross-sectional view of an embodiment of a mold apparatus 202d configured to define one or more extrusion channels 208d. As shown, the extrusion channels 208d may be defined by walls 402 and side walls 1200 of the mold apparatus 202d. In some embodiments, the mold apparatus 202d may include one or more dividers that separate adjacent extrusion channels 208d, thereby forming multiple parallel strips of fresh cementitious material as the composition exits the extruder head. Each extrusion channel 208d may be configured to define a desired cross-sectional geometry of the resulting extruded cementitious strips (rather than a continuous cementitious sheet). For example, each extrusion channel 208d may have a width W3 and a height H1 selected to produce extruded cementitious strips having corresponding dimensions. The extrusion channels 208d may be substantially uniform or may vary depending on the desired product configuration. The spacing between each individual strip 1300a may be defined by the geometry of the walls 402.

As further illustrated in FIG. 13, the continuous cementitious strips 1300a formed by the extrusion channels 208d may extend downstream as elongated cementitious members, which may subsequently be cut (e.g., along cut line 1302a) into individual cementitious products of desired length. It will be appreciated that the mold apparatus 202d may be configured to produce either a continuous cementitious sheet or multiple discrete cementitious strips, depending on the configuration of the extrusion channels 208d and associated structures.

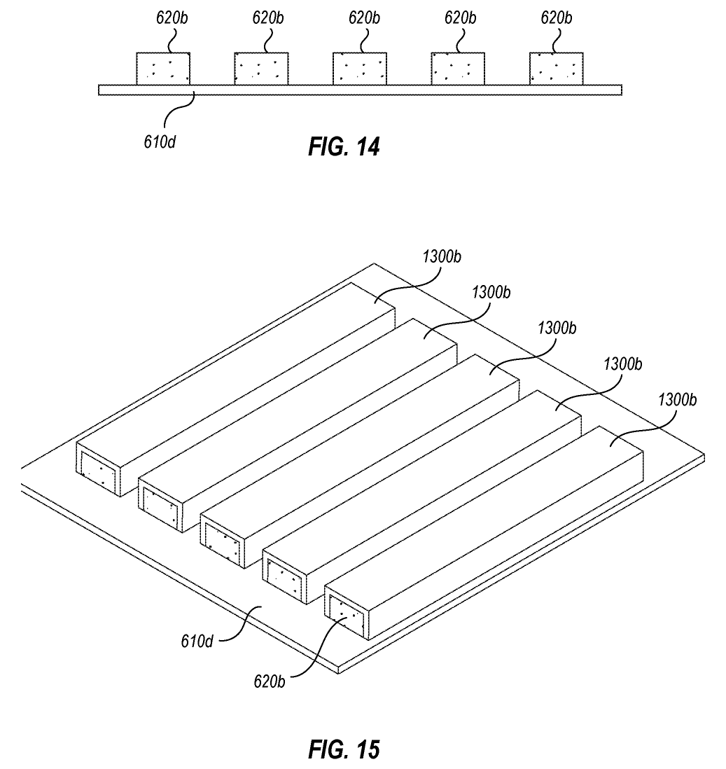

FIG. 14 illustrates an embodiment of an extrusion platform 610d having a plurality of extrusion substrates 620b mounted thereon. The extrusion substrates 620b may be positioned on the extrusion platform 610d in a desired arrangement to receive a fresh cementitious composition during an extrusion process. In at least one embodiment, another extrusion substrate may be positioned between each extrusion substrate 620b and the extrusion platform 610d. Here, the extrusion substrates 620b may be configured to form an internal portion of a resulting cementitious product. In some embodiments, the extrusion substrates 620b may comprise a lightweight or low-density (e.g., expanded polystyrene) material, thereby reducing the overall weight of the resulting product. A coating, spray, or similar adhesive promoting agent may be administered between the extrusion substrate 620b and the extrusion platform 610b.

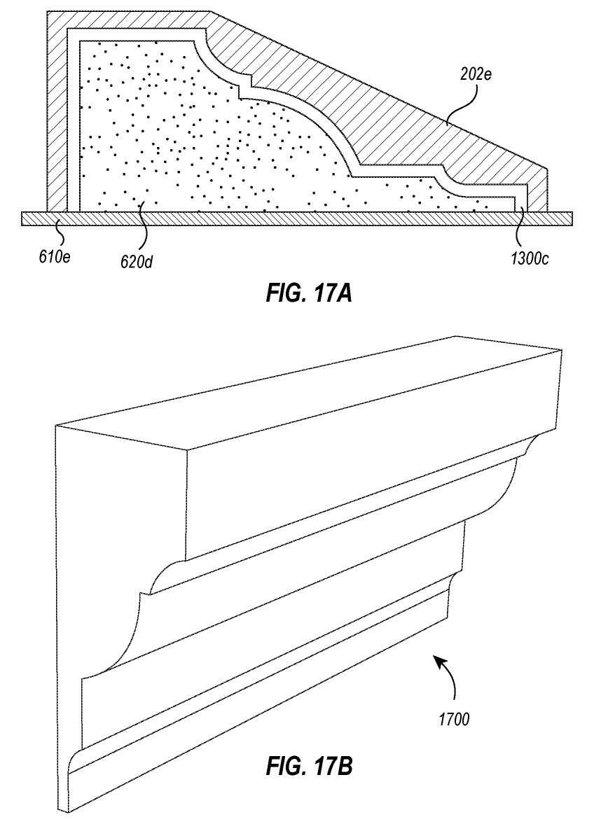

FIG. 15 illustrates the extrusion platform 610d and extrusion substrates 620b after fresh cementitious shells (formed from continuous strips 1300b) have been extruded thereon. As shown, the fresh extruded cementitious shells (formed from continuous strips 1300b) may be deposited over the extrusion substrates 620b to form a cementitious layer that at least partially surrounds the extrusion substrates 620b, thereby forming a composite cementitious product. The fresh cementitious composition (in the form of continuous strips 1300b) may be applied to cover one or more surfaces of the extrusion substrates 620b to form a desired outer shape, while the extrusion substrates 620b define an inner core. The resulting cementitious composite product may subsequently be cut, cured, or otherwise processed to form individual architectural cementitious products. It will be appreciated that the number, shape, and arrangement of the extrusion substrates 620b may be varied depending on the desired configuration of the final product, and that the extrusion process may be adapted to produce a wide variety of composite cementitious structures. Further examples can be seen in FIGS. 17A and 17B.

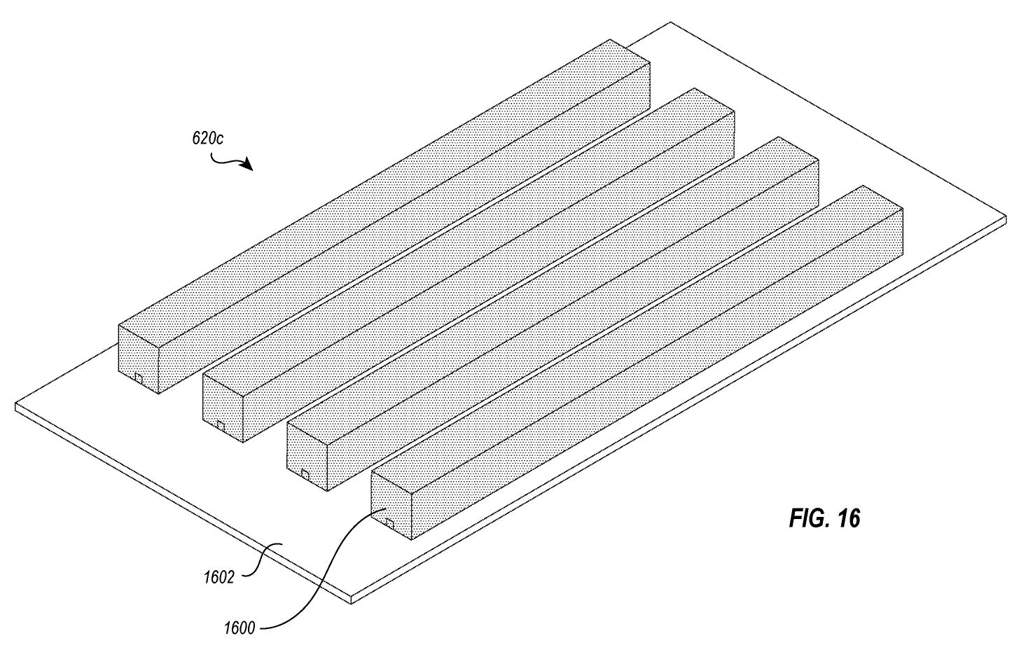

FIG. 16 illustrates another embodiment of an extrusion substrate 620c that may be used in conjunction with an extrusion platform, such as those described herein. The extrusion substrate 620c may include a base portion 1602 and one or more upper portions 1600 positioned thereon. The one or more upper portions 1600 may be configured to form internal portions of resulting cementitious products, similar to the extrusion substrates 620b described with respect to FIG. 14. The upper portions 1600 (and base portion 1602) may be formed from a lightweight or low-density material (e.g., expanded polystyrene) and may define the shape and geometry of inner cores of the desired finished cementitious products. The upper portions 1600 may be removably coupled to the base portion 1602. In some embodiments, the upper portions 1600 and base portion 1602 may engage via one or more mechanical features, such as tabs, grooves, interlocking structures, or friction-fit connections. In other embodiments, an adhesive or other releasable coupling mechanism may be used to secure the upper portions 1600 to the base portion 1602. The coupling may be configured to maintain the upper portions 1600 in a fixed position during extrusion while still allowing the upper portions 1600 to be removed from the base portion 1602 after the cementitious composition has been applied.

The base portion 1602 may thus remain on the extrusion platform and may be reused for subsequent extrusion cycles. This configuration may provide several non-limiting advantages. For example, the use of one or more removable upper portions 1600 may reduce contamination or buildup of cementitious material on the underlying extrusion platform or base portion 1602, thereby facilitating faster turnaround between production cycles.

FIG. 17A illustrates an embodiment of an extrusion system including a mold apparatus 202e configured to form the cementitious composition 1300c into a shaped profile. As shown, the cementitious composition 1300c may be extruded over extrusion substrates 620d positioned on an extrusion platform 610e. The mold apparatus 202e may define a contoured or non-linear cross-sectional geometry such that the cementitious composition 1300c is formed into a shaped profile as it is conveyed relative to the extruder head. The extrusion substrates 620d may be configured to correspond to or complement the shape defined by the mold apparatus 202e, such that the cementitious composition 1300c is applied over the extrusion substrates 620d to form a composite structure.

FIG. 17B illustrates an example of a resulting architectural cementitious product 1700 formed using the system of FIG. 17A. In the illustrated embodiment, the cementitious product 1700 may have a contoured cross-sectional shape, such as a crown molding profile. It will be appreciated, however, that a wide variety of other product shapes may be produced, including trim elements, panels, decorative features, structural members, or other architectural cementitious products. Though not seen from this view, the extrusion substrates 620d may define an internal core of the product 1700, while the extruded cementitious composition forms a shell layer surrounding the core. The use of a lightweight (e.g., expanded polystyrene foam) internal core may reduce the overall weight of the product 1700, while maintaining rigidity and structural integrity provided by the outer cementitious layer. This configuration may provide advantages in handling, installation, and material efficiency. The resulting product 1700 may subsequently be cut, cured, finished, or otherwise processed as needed.

It will be appreciated that the embodiments illustrated in FIGS. 11-17B demonstrate the ability of the conveyor and extrusion systems described herein to produce a wide range of shaped cementitious products. The various features of each example embodiment may be interchanged or modified without limitation to achieve different product configurations.

### Cutting Systems

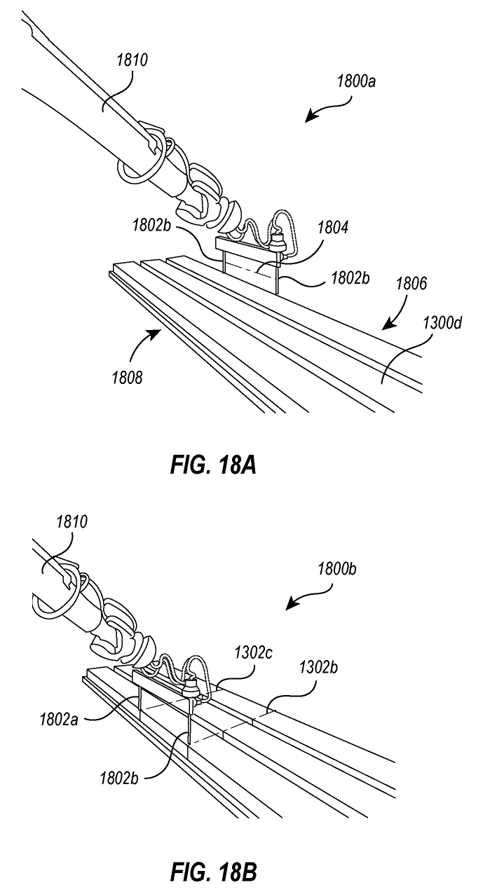

FIGS. 18A and 18B illustrate a cutting system or subsystem, with a cutting mechanism 1810 in a first position 1800a and a second position 1800b, respectively. FIGS. 18A and 18B depict the movement and operation of the cutting mechanism as it traverses across extruded cementitious material to perform one or more transverse cuts. In the embodiment shown, the cutting mechanism 1810 comprises a water-jet cutting assembly; however, other cutting means may be used in alternative embodiments, including a high-pressure abrasive water jet, rotary blade cutter, reciprocating saw blade, wire cutter, heated wire element, laser cutter, or any suitable mechanical or non-mechanical cutting tool capable of producing a clean transverse cut through the cementitious material. The cutting mechanism 1810 may be mounted to a robotic arm that enables multi-axis positioning, although in other embodiments, the cutting mechanism may be mounted to a rail system, gantry system, track-guided carriage, or other automated or semi-automated motion platform. As shown, the cutting mechanism 1810 is used to cut strips 1300d (e.g., perpendicular to the conveyance direction) while the strips 1300d are conveyed or otherwise placed beneath it. The strips 1300d may be thin bricks or they may form a coating or shell disposed over an inner core, such as the product 1700 shown in FIG. 17B.

FIG. 18A illustrates the cutting mechanism 1810 in a first position 1800a positioned adjacent a first side 1806 of the conveyance system or cutting station, such as at the beginning of a cutting cycle. The cutting mechanism 1810 includes one or more cutting nozzles 1802a and 1802b. In the embodiment shown, two nozzles are provided, and both may operate simultaneously to cut across the width of the strips 1300d. Although two nozzles are shown, a single nozzle may be used at a time, allowing the system to perform sequential cuts or selective cuts depending on product type or desired production parameters. The nozzles 1802a and 1802b are spaced apart by a distance 1804, which can be selected to correspond to a desired product length or cut interval when the nozzles are operated together.

In instances where the strips 1300d are conveyed immediately after extrusion, they may still be wet or plastic at the time of cutting. Cutting while wet can make cutting easier and produce cleaner edges. In other embodiments, the strips 1300d may be cut after the material has hardened or cured sufficiently to maintain dimensional stability during cutting. By way of example, the extruded cementitious composition and strips or other parts made therefrom can be cut while in a green state (e.g., within 1 minute to 6 hours, or 5 minutes to 3 hours, or 10 minutes to 2 hours), after partially hardening (e.g., within 12-24 hours), or after hardening (e.g., after 24 hours).

FIG. 18B illustrates the cutting mechanism 1810 in a second position positioned adjacent a second side 1808 of the conveyance system, such as at the end of a cutting cycle. In this position, the cutting nozzles 1802a and 1802b have traversed across the strips 1300d and produced transverse cut lines 1302b and 1302c. These cut lines correspond to the paths generated by the nozzles 1802a and 1802b as the cutting mechanism 1810 moves from the first side 1806 toward the second side 1808. As the strips 1300d continue to advance along the conveyance system, the cutting mechanism 1810 can complete a full transverse cut by moving from one side of the strips to the other in a direction that is perpendicular to the conveyance direction.

After completing a cut on the second side 1808, the cutting mechanism 1810 can return to the first side 1806 to prepare for the next cutting cycle. In another embodiment, the cutting mechanism 1810 may perform cuts in both directions, moving from the first side 1806 toward the second side 1808 and then making the next cut while moving from the second side 1808 back toward the first side 1806. Bidirectional operation can increase throughput and reduce cycle time by eliminating the need for a non-cutting return movement. Accordingly, the present disclosure provides for extrusion, shaping, and cutting of cementitious material within the same conveyance system.

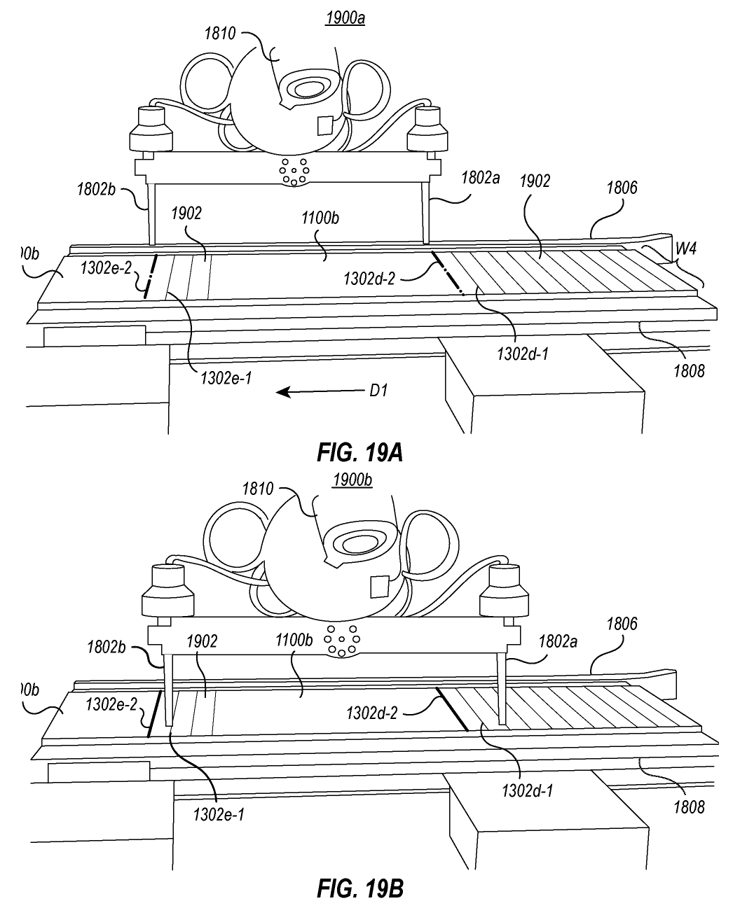

FIGS. 19A and 19B illustrate a cutting mechanism 1810 operating on a flat, continuous or discontinuous cementitious sheet 1100b of extruded cementitious material in a third position 1900a and a fourth position 1900b, respectively. The cutting mechanism 1810 comprises a first cutting nozzle 1802a and a second cutting nozzle 1802b. In this embodiment, the cementitious material being cut has been extruded as a cementitious sheet 1100b rather than as a plurality of discrete strips (such as in FIGS. 18A and 18B) prior to being cut into thin bricks or strips 1902. The cutting mechanism 1810 operates in a manner similar to that described with respect to FIGS. 18A and 18B, with the cementitious sheet 1100b having been conveyed or placed beneath the cutting mechanism 1810 prior to cutting and then remaining stationary during the cutting procedure. For example, the cementitious sheet 1100b may have been conveyed underneath in the direction D1.

At the beginning of an example cutting process, the first cutting nozzle 1802a can be positioned at or near a first side 1806 of the cementitious sheet 1100b, while the second cutting nozzle 1802b can be positioned at or near a middle portion of the cementitious sheet 1100b. In this configuration, the cutting mechanism 1810 may move from the first side 1806 toward the second side 1808 through a series of cutting cycles to form a plurality of thin bricks or strips 1902 of desired width. Alternatively, the relative positions of the cutting nozzles 1802a and 1802b may be reversed such that the cutting mechanism 1810 moves from the second side 1808 toward the first side 1806. The length of each thin brick or strip 1902 may be defined by the width W4 of the cementitious sheet 1100b, unless further trimmed or cut, while the spacing between adjacent cut lines (e.g., between 1302d-1 and 1302d-2, and between 1302e-1 and 1302e-2) corresponds to the width of each thin brick or strip 1902. After each cutting cycle, the cutting mechanism 1810 may be translated along the length of the cementitious sheet 1100b by a distance substantially equal to the width of the thin bricks or strips 1902 to initiate the next cutting cycle.

FIGS. 19A and 19B further illustrate the cutting mechanism 1810 positioned at opposing sides 1806, 1808 of the cementitious sheet 1100b after a number of cutting cycles have been performed. As shown in FIG. 19A, the first cutting nozzle 1802ahas already formed cut line 1302d-1. FIG. 19B is illustrated after the formation of adjacent cut line 1302d-2, thereby forming a thin brick or strip 1902. Similarly, FIG. 19A shows cutting nozzles 1802bhas already formed cut line 1302e-1, while FIG. 19B shows the formation of adjacent cut line 1302e-2 to form another thin brick or strip 1902. Explained differently, during a first cutting cycle, the first cutting nozzle 1802a forms cut line 1302d-1 while the second cutting nozzle 1802b simultaneously forms cut line 1302e-1. During a subsequent cutting cycle, the cutting mechanism 1810 is translated by a distance corresponding to the width of a thin brick or strip 1902, and the first cutting nozzle 1802a forms cut line 1302d-2 while the second cutting nozzle 1802bsimultaneously forms cut line 1302e-2.

The cementitious sheet 1100b is supported by a conveyor system while the cutting mechanism 1810 is moved through successive cutting cycles. In at least one embodiment, the conveyor system may move the cementitious sheet 1100b during the cutting process. In some embodiments, the cutting direction of the nozzles 1802a, 1802b may be adjusted to form transversely cut thin bricks of shorter length (e.g., segmenting the brick along width W4).

In some embodiments, each cut line (e.g., 1302d-2 and 1302e-2) may be traversed one or more times by the cutting nozzles 1802a, 1802b to ensure complete separation of adjacent thin bricks or strips 1902. In other embodiments, one or more cut lines may extend through less than the full thickness of the continuous sheet 1100b to form perforations that facilitate subsequent separation. During operation, the cutting mechanism 1810 may move back and forth while the continuous sheet 1100b advances along the conveyance system in direction D1 or while the sheet remains stationary. In some embodiments, the cutting mechanism 1810 may also translate along direction D1 or opposite direction D1 to position the cutting nozzles 1802a, 1802b at desired cutting locations. This coordinated motion enables precise control over cut spacing, cut depth, and final thin brick dimensions while maintaining continuous material processing.

### Methods of Manufacturing

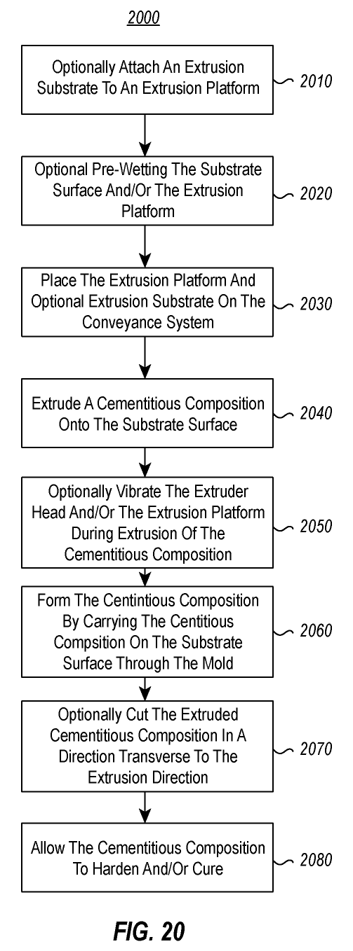

Also disclosed are methods for manufacturing cementitious products. The method may utilize any component, element, or structural piece from any of the above embodiments and examples without limitation. FIG. 20 illustrates a flowchart of an example cementitious composition shaping method 2000. The method 2000 optionally includes attaching one or more extrusion substrates (such as extrusion substrate 620a) to an extrusion platform (such as extrusion platform 610a) at step 2010. The extrusion substrates can include low-density materials, such as lightweight foam concrete, lightweight foam ceramic, expanded polystyrene (EPS), extruded polystyrene foam (XPS), polyurethane foam, cement-bonded wood fiber, cement-bonded polystyrene beads, cellular concrete, or similar materials, as described above. The method 2000 may optionally include pre-wetting the surface (i.e., a surface of the extrusion platform 610a or the surface of one or more extrusion substrates 620a) at step 2020. Pre-wetting may include misting or spraying a surface with, for example, a release agent.

At step 2030, the extrusion platform may be placed on the conveyor system (e.g., conveyor system 600a). The extrusion platform may be carried by the conveyor system through or along the extrusion system or an extruder head (e.g., extruder head 200a). In particular, the conveyor system may carry the extrusion platform to a position under the extruder head of the extrusion system.

The method 2000 further includes extruding (or applying) a cementitious composition onto a surface of an extrusion substrate or directly onto an extrusion platform at step 2040. As described above, a fresh cementitious composition may be applied or extruded via the extruder head. The fresh cementitious composition may be delivered to the extruder head under a first pressure, and the extruder head may extrude and/or apply the fresh cementitious composition under a second pressure. The first and second pressures may be the same. Alternatively, the first and second pressures may be different. The first pressure may range from about 20 to about 40 psi. The second pressure may range from about 10 to about 35 psi.

The method 2000 may optionally further include vibrating the extruder head and/or the extrusion platform at step 2050. Vibrating the extrusion platform and/or the extruder head may cause the fresh cementitious composition to more uniformly flow and spread across the extrusion platform and any intervening extrusion substrates. Beneficially, vibrating the fresh cementitious composition also removes air bubbles in the cementitious composition as it is applied to the application surface of the substrate and/or extrusion platform. Further beneficially, vibrating the extrusion platform and/or the extruder head may cause the extruded cementitious composition to flow into and fill pores in an extrusion substrate, enabling a stronger bond between the cementitious composition and the extrusion substrate.

At step 2060, the cementitious composition may be formed by passing the fresh cementitious composition through the mold apparatus of the extrusion head. The mold apparatus may be configured to form the fresh cementitious composition into a desired shape or form. For example, the mold apparatus may comprise side walls, walls, dividers, etc., to form the fresh cementitious composition into continuous parallel strips or sheets as a precursor to forming thin bricks or other products. The fresh cementitious composition may be carried through the mold apparatus in an extrusion direction (i.e., direction D1) by the extrusion platform on which it is disposed, the extrusion platform being conveyed by one or more conveyor systems.

The method 2000 may optionally include step 2070 comprising cutting the extruded cementitious composition. In at least one embodiment, the extruded cementitious composition may be cut in a direction transverse to the extrusion direction D1. The method 2000 may also include allowing the extruded cementitious composition to harden and/or cure at step 2080. The cementitious composition may remain on the extrusion platform during the hardening and/or curing step 2080. The cementitious composition may be allowed to harden and/or cure before step 2070 wherein the cementitious composition is cut. However, in alternative embodiments, the cementitious composition may be cut before the hardening and/or curing step 2080 (i.e., while the cementitious composition is in a green condition, such as prior to or after initial set, after initial set and prior to final set, or after final set because substantially hardening has occurred (i.e., within 1-6 hours after extrusion, or within 6-12 hours after extrusion, or within 12-24 hours after extrusion).

The disclosed conveyor and extrusion system and method for forming thin bricks and other architectural cementitious products offer significant benefits in terms of efficiency, cost reduction, and product uniformity. By automating the conveying and extrusion process, the system minimizes the need for manual labor, which traditionally involves manually casting and demolding cementitious compositions to form thin bricks and other architectural cementitious products. This automation process not only reduces labor costs but also accelerates production time, allowing for higher output and meeting increased demand for thin bricks and other architectural cementitious products. Additionally, the disclosed systems and methods ensure consistent quality and uniformity in the size, shape, and appearance of the cementitious products, which is crucial for maintaining structural integrity and aesthetic appeal in construction projects.

Users will appreciate the extrusion system’s ability to extrude fresh cementitious compositions into continuous lengths of thin brick or other architectural cementitious products, offering precise control over dimensions and cross-sectional shape. The systems of the disclosure feature an extruder head with a manifold and mold apparatus that can be selectively attached to form various geometric or non-geometric shapes, including rectangular strips for thin bricks. The inclusion of a vibrating mechanism or a heavily pressured inlet flow can further enhance the extrusion process by ensuring even distribution of the fresh cementitious composition and facilitating the removal of air bubbles, resulting in a smoother and more durable final product. This innovative approach enables greater flexibility in manufacturing and customization, tailored to specific project requirements.

Moreover, the extrusion system incorporates a conveyance system that guides the extrusion platform in a controlled and aligned manner, ensuring accurate positioning relative to the extruder head. These systems can include pinions, axles, belts, gears, and rollers that work in tandem to move the platform and maintain stability during the extrusion process. The use of extrusion substrates, such as lightweight foam concrete or expanded polystyrene, further reduces the weight of the final product while maintaining its structural integrity. These substrates can be pre-wetted to enhance bonding with the freshly applied cementitious composition, preventing cracking and improving overall durability. The combination of these inventive features makes the extrusion system a highly efficient and versatile solution for manufacturing thin brick and other cementitious products.

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

The embodiments disclosed herein should be understood as comprising/including disclosed components, and may therefore include additional components not specifically described. Optionally, the embodiments disclosed herein are essentially free or completely free of components that are not specifically described. That is, non-disclosed components may optionally be completely omitted or essentially omitted from the disclosed embodiments.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A system for manufacturing a cementitious composition into a desired form, comprising:
an extruder head including:
a manifold; and
an inlet extending from the manifold of the extruder head;
a mold apparatus associated with the extruder head, the mold apparatus configured to partially shape the extruded cementitious composition into a desired cross-sectional shape;
an extrusion platform having one or more linear racks, the extrusion platform configured to partially shape the extruded cementitious composition; and
a conveyor system configured to guide the extrusion platform in a direction relative to the extruder head.

2. The system of claim 1, wherein the conveyor system comprises one or more pinions configured to engage the one or more linear racks of the extrusion platform to guide the extrusion platform in a direction relative to the extruder head.

3. The system of claim 1, wherein the conveyor system comprises one or more transmission chains configured to engage the one or more linear racks of the extrusion platform to guide the extrusion platform in a direction relative to the extruder head.

4. The system of claim 3, wherein the one or more linear racks of the extrusion platform are disposed on one or more side edges of the extrusion platform.

5. The system of claim 3, wherein the one or more linear racks comprises a first linear rack and a second linear rack, wherein the one or more transmission chains comprise a first transmission chain and a second transmission chain, wherein the first linear rack is configured to engage with the first transmission chain simultaneously as the second linear rack engages with the second transmission chain.

6. The system of claim 1, wherein the system is configured to extrude one or more lengths of the extruded cementitious composition onto the extrusion platform.

7. The system of claim 1, wherein the system is configured to extrude one or more lengths of the extruded cementitious composition over an extrusion substrate.

8. The system of claim 7, wherein the extrusion substrate is disposed on the extrusion platform.

9. The extrusion system of claim 8, wherein the extrusion substrate comprises a lightweight foam concrete, lightweight foam ceramic, expanded polystyrene (EPS), extruded polystyrene foam (XPS), polyurethane foam, cement-bonded wood fiber, cement-bonded polystyrene beads, or cellular concrete.

10. The system of claim 1, wherein the system further comprises a cutting system.

11. A system for manufacturing a cementitious composition into a desired form, comprising:
an extruder head;
a mold apparatus extending from the extruder head, wherein the mold apparatus is configured to shape the cementitious composition;
a transmission chain configured to move linearly and horizontally positioned adjacent to the extruder head; and
an extrusion platform having a length and a width, wherein a linear rack is disposed along a first edge that defines the length,
wherein the transmission chain is configured to engage the linear rack to move the extrusion platform relative to the extruder heads.

12. The system of claim 11, wherein the system further comprises a mixing system and a pump system that transports the cementitious composition to the extruder head.

13. The system of claim 11, wherein the transmission chain is configured to limit a vertical movement of the extrusion platform relative to the extruder head.

14. The system of claim 11, wherein the system extrudes two or more continuous strips of cementitious composition.

15. The system of claim 11, wherein the extrusion platform is a first extrusion platform and the system comprises a second extrusion platform, wherein the first extrusion platform has a first partial tooth and the second extrusion platform a second partial tooth, wherein the first partial tooth and the second partial tooth configured to form a full tooth when the first extrusion platform and second extrusion platform are placed end to end.

16. The system of claim 15, wherein an index of the second extrusion platform is configured to be received within a notch of the first extrusion platform.

17. A method of extruding a cementitious composition into a desired shape, the method comprising:
providing an extrusion platform including a surface;
placing the extrusion platform on a conveyor system;
carrying the extrusion platform beneath an extruder head;
extruding the cementitious composition onto a surface of the extrusion platform and/or a surface of an extrusion substrate on the extrusion platform;
forming, at the extruder head, the cementitious composition into a continuous sheet or strip by conveying the extrusion platform in a direction relative to the extruder head as the cementitious composition is deposited onto the extrusion platform; and
allowing the cementitious composition to harden and/or cure.

18. The method of claim 17, further comprising attaching an extrusion substrate to the extrusion platform before extrusion of the cementitious composition the surface of the extrusion substrate.

19. The method of claim 18, wherein a portion of the extrusion substrate becomes an inner core that is surrounded by a shell formed by the continuous sheet or strip.

20. The method of claim 17, further comprising cutting the cementitious composition to form a thin brick.
